(19) United States
(12) Patent Application Publication
(10) Pub. No.: US 2018/0338163 A1
(43) Pub. Date: Nov. 22, 2018

(54) PROXIES FOR LIVE EVENTS

(71) Applicant: International Business Machines Corporation, Armonk, NY (US)

(72) Inventors: Aaron K. Baughman, Silver Spring, MD (US); Gary F. Diamanti, Wake Forest, NC (US); Nicholas A. McCrory, Sacramento, CA (US); Michelle Welcks, Tampa, FL (US)

(21) Appl. No.: 15/598,548

(22) Filed: May 18, 2017

(51) Int. Cl. H04N 21/235; H04N 21/2187; H04N 21/258; H04N 21/233; H04N 21/222; H04N 21/8545; H04N 21/475

(52) U.S. Cl. CPC H04N 21/235; H04N 21/2187; H04N 21/25875; H04N 21/25891; H04L 67/12; H04N 21/222; H04N 21/8545; H04N 21/4758; H04N 21/233

(57) ABSTRACT

A hardware processor receives a selection of an avatar by users and a transmission of a live video stream from the avatar. The live video stream is transmitted to the users. Votes are received from the users. Each vote is a command to be performed by the avatar. Based on the received votes, a selected command to be performed by the avatar is determined. The selected command is transmitted to the avatar for execution thereby.

### BACKGROUND

Attending a live event is a unique experience that often involves a variety of activities not commonly captured by network broadcasts. For example, a network broadcast of a live event, such as a tennis match, may only focus its coverage on high profile participants or matches while providing little to no coverage of other participants or portions of the event. In addition, even when the network broadcast focuses on a particular participant or portion of the event, the participant or portion of the event match may not always be shown by the broadcast network to its audience. For example, in a tennis match, any stoppage in play may result in a cut to a commercial or other advertisement. In addition, the network coverage may switch between views of the various participants during the match so that some facial expressions or other body language of a particular participant may not be provided to the audience.

An attendee of a live event, on the other hand, has the opportunity to pick and choose what portions or participants of the live event to watch, where to look during the event, and what other activities to participate in other than viewing the participants of the event.

### BRIEF SUMMARY

The system, method, and computer program product described herein provide remote participants or non-live attendees of a live event with the capability to attend the live event through the use of inorganic and organic avatars.

In an aspect of the present disclosure, a method is disclosed. The method includes receiving a broadcast from an avatar. The method further includes receiving a selection of the avatar by a plurality of remote users, receiving from the avatar a transmission of a live video stream, transmitting the live video stream to the plurality of remote users, receiving votes from at least some of the plurality of users for control of the avatar, each vote comprising a command to be performed by the avatar, determining, based on the received votes, a selected command to be performed by the avatar, and transmitting the selected command to the avatar for execution by the avatar.

In an aspect of the present disclosure, the method may further include determining that a premium remote user has selected the avatar. In some aspects, the premium remote user has selected a pricing tier that is more expensive than a pricing tier selected by the plurality of remote users. The method may further include receiving from the premium remote user a bid for control of the avatar, determining that the received bid is a highest bid received for control of the avatar, in response to determining the received bid is the highest bid, providing the premium remote user with control of the avatar, receiving from the premium remote user a selection of a command to be performed by the avatar, and transmitting the command selected by the premium remote user to the avatar for execution by the avatar, wherein the command selected by the premium remote user overrides the command selected based on the received votes.

In aspects of the present disclosure apparatus, systems, and computer program products in accordance with the above aspect may also be provided. Any of the above aspects may be combined without departing from the scope of the present disclosure.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is a system diagram illustrating a system for providing avatars for remote users according to an aspect of the present disclosure.

FIG. 2 is an example user interface according to an aspect of the present disclosure.

FIG. 3 is a block diagram illustrating connections between remote users and avatars according to an aspect of the present disclosure.

FIG. 4 is a flow chart of a method according to an aspect of the present disclosure.

FIG. 5 is an exemplary block diagram of a computer system in which processes involved in the system, method, and computer program product described herein may be implemented.

FIG. 6 depicts a cloud computing environment according to an embodiment of the present invention.

FIG. 7 depicts abstraction model layers according to an embodiment of the present invention.

### DETAILED DESCRIPTION

Event venues often have limited space, seating, or other capacity for live attendees to join and watch an event. For example, an event venue may sell a predetermined number of tickets to an event that correspond to the limited capacity of the venue. Only those individuals having tickets may be allowed to attend the event as a live attendee. The result of this limited capacity is that the vast majority of patrons or fans of an event may be unable to access the physical space of the venue due. For example, for popular events, the limited number of tickets may sell out before a fan or patron of the event can purchase them or the tickets themselves may become too expensive for a majority of the fans or patrons to purchase them. In some cases, a fan or patron may have a scheduling conflict that does not allow the fan or patron to travel to the event venue. In some cases, the fan or patron may wish to stay in the comfort of their home. Regardless of the reason, a vast majority of fans or patrons may not be able to physically attend an event as a live attendee.

Event venues are looking for ways to bring fans or patrons back into the venue and are often building larger venues that have increase physical capacity to accommodate additional fans or patrons. With easy access to the internet, however, many fans or patrons no longer attend live events at a venue and instead access the content through mobile devices or other cloud services. This results in fans and patrons that are not as engaged or connected to the event. Without this direct engagement or connection to the fans or patrons, the participants of the event, e.g., sports teams, the event venue, etc., may lose revenue.

In some aspects, the present disclosure provides new ways to engage and connect fans or patrons with events, for example, by providing a customizable user experience through the use of a live person, referred to herein as an avatar, live avatar, or organic avatar. Live avatars provide additional feedback mechanism for engaging remote users to allow the remote users to engage with the event venues in new and novel ways. For example, live avatars may provide users with a human perspective of an event venue including feedback other than just visual or audio streams. Although the following is described predominantly with reference to live avatars, any of the below mechanisms may also be utilized with inorganic avatar, for example, a robotic avatar, drone, unmanned aerial vehicle (UAV) or other similar machines or devices. For example, robotic avatars may provide advantages different from live human avatars in certain situations including, for example the ability to reach dangerous locations such as the inside of a volcano, a deep mine shaft, or even an off world flight.

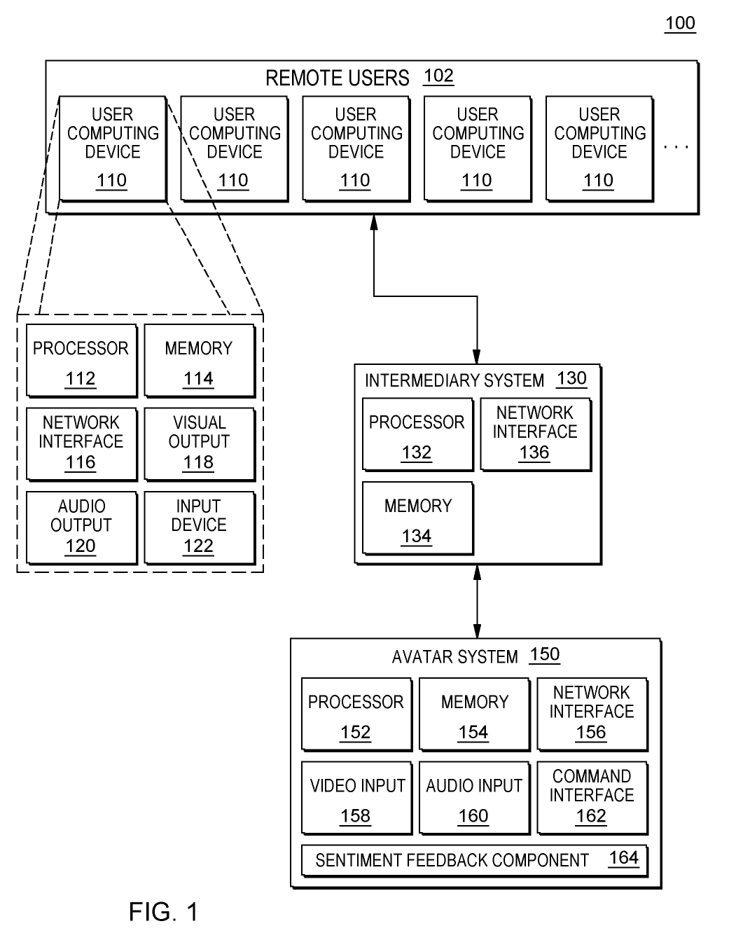

With reference now to FIG. 1, a system 100 is illustrated. In some aspects, system 100 includes remote users 102, an intermediary system 130, and an avatar system 150. Remote users 102 may be any user of system 100 that wishes to access or control a live avatar at an event venue. Each remote user 102 may have a user computing device 110 that may be used by the remote user 102 to communicate with and submit commands to the live avatar.

In some aspects, each user computing device 110 includes at least one processor 112, memory 114, at least one network interface 116, a display 118, an input device 120, an output device 122, and may include any other features commonly found in a computing device. In some aspects, user computing devices 110 may, for example, be any computing devices that are configured to provide a remote user 102 with access to avatar system 150. In some aspects, user computing device 110 may include, for example, personal computers, laptops, gaming systems, tablets, smart devices, smart phones, smart watches, smart tvs, virtual reality devices or any other similar computing device.

Processor 112 may include, for example, a microcontroller, Field Programmable Gate Array (FPGAs), or any other processor that is configured to perform various operations. Processor 112 may be configured to execute instructions as described below. These instructions may be stored, for example, in memory 114.

Memory 114 may include, for example, non-transitory computer readable media in the form of volatile memory, such as random access memory (RAM) and/or cache memory or others. Memory 114 may include, for example, other removable/non-removable, volatile/non-volatile storage media. By way of non-limiting examples only, memory 114 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 116 is configured to transmit and receive data or information to and from an intermediary system 130, avatar system 150, or any other computing device via wired or wireless connections. For example, network interface 116 may utilize wireless technologies and communication protocols such as Bluetooth®, WWI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 110 to transmit or receive information to or from intermediary system 130 or avatar system 150.

Visual output 118 may include, for example, a computer display, television, smart television, a display screen integrated into a personal computing device such as, for example, laptops, smart phones, smart watches, virtual reality headsets, smart wearable devices, or any other mechanism for displaying information to a user. In some aspects, visual output 118 may include a liquid crystal display (LCD), an organic LED (OLED) display, or other similar display technologies. In some aspects, display 118 may be touch-sensitive and may also function as an input device 120.

Audio output 120 may include, for example, a speaker, or other similar output devices that may present non-visual outputs to the user. For example, audio data may be received from avatar system 150 and output by audio output 120 so that a remote user 102 can hear the event at the event venue or other audio data received from avatar system 150.

Input device 122 may include, for example, a keyboard, a mouse, a touch-sensitive display, a keypad, a microphone, or other similar input devices or any other input devices that may be used alone or together to provide a user with the capability to interact with computing device 110.

Intermediary system 130 includes a processor 132, memory 134, and a network interface 136 that may include similar functionality as processor 112, memory 114, and network interface 116. In some aspects, intermediary system 130 may, for example, be a network of servers or computing devices that may be used to receive streaming data from avatar system 150 and transmit the received streaming data to computing devices 110. In some aspects, intermediary system 130 may also transmit commands received from computing device 110 to avatar system 150. In some aspects, for example, intermediary system 130 may be used as a proxy to provide low latency, high-volume network streams to the user computing devices 110 of the remote users 102. For example, intermediary system 130 may receive avatar data from the avatar system 150 in real time, e.g., live audio and video data, and may distribute the avatar data to a local network of servers that are responsible for serving high volumes of remote users 102. The local network of servers may then transmit the avatar data to the user computing devices 110 of the remote users 102 that have access to the live avatar. In some aspects, for example, intermediary system 130 may be a broadcast or telecom interface that streams data.

Avatar system 150 may be utilized by a live avatar to present an event to the user computing devices 110 of remote users 102 via intermediary system 130. In some aspects, avatar system 150 may alternatively communicate directly with user computing devices 110 without the need to communicate via intermediary system 130. Avatar system includes a processor 152, memory 154, and a network interface 156 that may include similar functionality as processor 112, memory 114, and network interface 116. In some aspects, avatar system 150 may also include a video input 158, audio input 160, and command interface 162.

In some aspects, for example, video input 158 may be a video camera or other similar device that is configured to capture images or video of the event at the event venue or of the venue itself. For example, video input may be mounted on or held by the live avatar and directed toward a participant of interest or toward any other portion of the venue. In some aspects, video input 158 may be mounted, for example, on the live avatar's head. The video input 158 may track the movement of the live avatar's head such that the remote users may experience the event “through the avatar's eyes” or point of view, for example, on a display, TV, or using virtual reality equipment. In some aspects, video input 158 may be an array of cameras or a 360 degree camera that allows users to explore the live avatar's surroundings in any direction, e.g., by panning the view or using a virtual reality headset to look in any direction that the user wants.

In some aspects, for example, audio input 160 may be a microphone or other device that is configured to capture audio data of the venue, event, or the avatar. For example, the audio input 160 may be mounted or held by the live avatar and directed toward a participant of interest. In some aspects, the live avatar may have an audio input 160 such as a microphone that is positioned adjacent to the avatar's mouth or positioned to capture audible signals when the avatar speaks. This audio input 160 may be used by the avatar to immediately relay information back to the remote users 102 in real time about what the avatar is experiencing aside from sight and sound. For example, the audio input 160 may used to capture descriptive language that the avatar uses to describe the surrounding event in the context of smell, crowd energy, or other similar features of the surrounding event that may not be captured or experienced directly by remote users 102 through display visual and audio outputs.

In some aspects, for example, command interface 162 may be configured to relay commands received from user computing devices 110 to the live avatar. For example, in some aspects, the command interface 162 may include a heads up display (HUD) or other display system that visually presents the commands received from user computing devices 110 to the live avatar. For example, the HUD may display arrows or other indicia that indicates a direction that the remote user or users 102 wish for the live avatar to turn. In some aspects, command interface 162 may include a computing device such as a mobile phone, smart watch, or other smart wearable technology that may present the user commands to the live avatar.

In some aspects, the command interface 162 may also present the live avatar with additional information on which points of interest the remote users 102 want the live avatar to view. For example, a map of the event venue may be presented on command interface 162 with a current location of the live avatar and a target location that the remote users 102 would like the live avatar to move to. In another example, the command interface 162 may present the live avatar with a schedule of events for the venue and indications of which events the remote users 102 would like the live avatar to attend. In another example, the command interface 162 may present the live avatar with a list of event participants and indications of which of the participants the remote users 102 would like the live avatar to follow or watch.

In some aspects, command interface 162 may include a haptic feedback system that applies pressure or vibrations to the live avatar, e.g., on a side of the live avatar that the user wants the live avatar to turn. For example, the live avatar may wear a hat, headband, or other article on his or her head that may include the command interface 162 in the form of, e.g., a vibrating pad or pressure inducing pad. When a command is received from a user computing device 110, for example, a command to turn left and look up, the command interface 162 may vibrate or press against the live avatar's left side and top of their head to indicate that the live avatar should look up.

In some aspects, command interface 162 may include an audio output that allows the remote users 102 to orally communicate with the live avatar. For example, a remote user 102 may speak and verbally command the live avatar to look at or move to a particular location in the venue. This verbal command may be more efficient, for example, where it may be hard for a non-verbal command to provide the same instruction. In some aspects, the live avatar may use the audio input 160 to verbally respond to the remote users 102 in response to the receipt of verbal or other communications from the remote users 102 via command interface 162.

In some aspects, a remote user 102 may purchase a right to command or control a live avatar at an event in real time. For example, the remote user 102 may pay a pre-determined fee for access rights to control the live avatar. The remote user 102 may then command the live avatar to navigate the event venue in real time according to the desires of the remote user 102 and focus on or look at particular participants of the event according to the desires of the remote user 102. The remote user 102 may command the avatar using any of the above mentioned methods including, for example, haptic feedback, visual identification of a desired direction, designation of a location on a map of the venue, verbal instructions, or any other method of indicating to the live avatar that the remote user 102 wishes for the avatar to view a particular participant or navigate to a particular location in the event venue. For example, the remote user 102 may input a command using input device 122 of the remote user 102's computing device 110, e.g., turn left, focus on a particular player, or other similar commands. The command may be transmitted to intermediary system 130 for retransmission, e.g., over a network, to the avatar system 150 or may be transmitted directly to avatar system 150. When avatar system 150 receives the command, avatar system may present the command to the live avatar via the command interface 162. The live avatar may then execute the command, for example, by turning his or her head or the video input 158 to the left or looking at the particular player.

In some aspects, the live avatar may be a private avatar that is available for control by a single remote user 102. In some aspects, additional remote users 102 may access the video and audio data output by avatar system 150 without having any ability to control the live avatar. For example, a first remote user 102 may pay a premium fee for the right to control the live avatar while other remote users 102 may pay a smaller fee for the right to piggyback or tag along or ride on the first remote user's use of the live avatar.

In some aspects, control of the live avatar may be based on a bidding system. For example, each remote user 102 that whishes to control the live avatar may place bids on controlling the live avatar, e.g., prior to or during the event or a time-slot within the duration of the event. In some aspects, for example, the live avatar may have pre-determined time slots that are available for control by remote users 102. In some aspects, the bidding for each time slot may close at a certain pre-determined period of time, for example, at the starting time for the time slot, 5 minutes before the time slot starts, or other similar pre-determined period of time. Each remote user 102 that wishes to bid on a particular time slot may select the time slot and place a bid. The remote user 102 with the highest bid at the close of the bidding for a particular time slot receives control of the live avatar for that time slot. In some aspects, the remote users 102 that did not win the bid may continue to experience the event venue through the live avatar by riding along on the winning bidder's use of the live avatar. In some aspects, the losing bidders may be required to pay a fee to continue experiencing the event through the live avatar while they wait to bid on the next time-slot.

In some aspects, the available capacity for use of a live avatar may be limited. For example, the avatar system 150 and intermediary system 130 may only be able to service a limited number of remote users 102. For example, the number of remote users 102 that may be able to use the live avatar may be 50, 100, 200, 500, or any other number of remote users 102. In some aspects, the remote users 102 may also bid on the right to experience the event venue through the live avatar. This bidding may be separate from bidding to control the live avatar or may be included as part of the bidding for the right to control the live avatar. For example, the top 50 bidders may be given the right to “ride” the live avatar while only the top bidder may be given the right to control the live avatar.

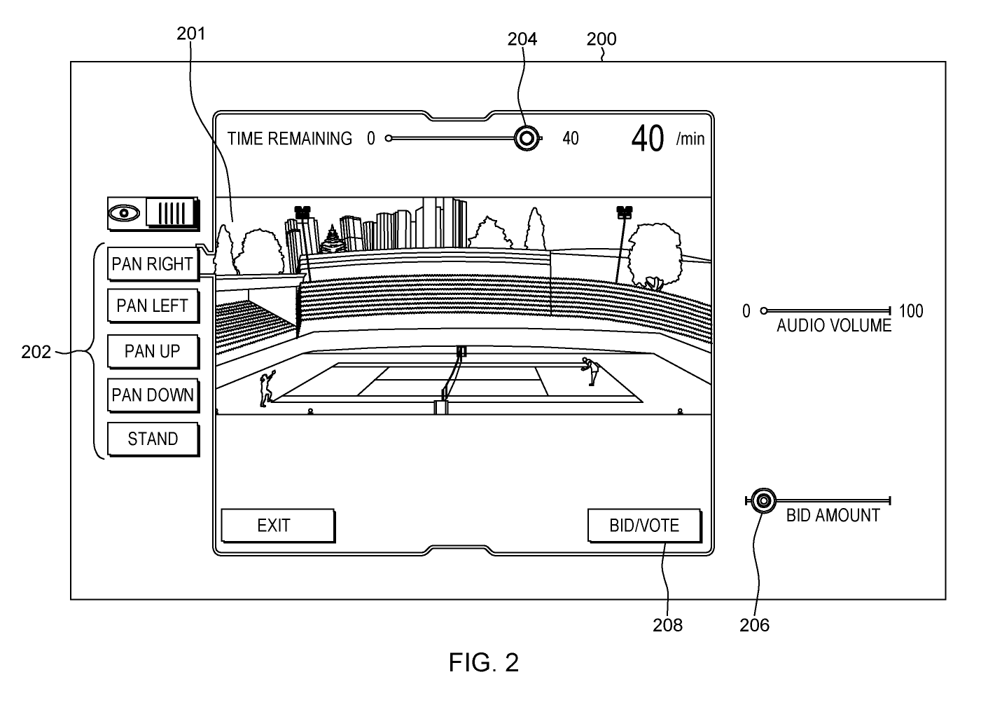

In some aspects, with reference now to FIG. 2, an example user interface 200 may be presented to remote users 102 by user computing devices 110, for example, via visual output 118. User interface 200 presents a remote user 102 with a live video stream 201, movement commands 202 for controlling avatar movements, e.g., pan right, pan left, pan up, pan down, and stand, a timer 204, a bid amount selector 206, and a bid/vote element 208.

Live video stream 201 may be a video stream received from intermediary system 130 or directly from avatar system 150. The video stream may be generated by video input 158 of avatar system 150 and transmitted to intermediary system 130 or a user computing device 110 of a remote user 102 and presented on visual output 118 of user computing device 110 via user interface 200 for viewing by remote user 102.

Movement commands 202 may be activatable separately or in combination by the remote user 102, for example, via input device 122, to transmit a corresponding command to avatar system 150 either directly or via intermediary system 130. For example, activation of the pan right command may transmit a command to avatar system 150 that the live avatar should pan the view to the right. Movement commands 202 may be any command that may be given to an avatar, for example, looking in a certain direction, moving to a certain location, or any other command or combination of commands in addition to the example commands illustrated in FIG. 2.

Timer 204 provides the remote user 102 with an indication of the remaining time that the remote user 102 is in control of the avatar, for example, the remaining time in the current time slot.

Bid amount selector 206 is activatable by the remote user, for example, via input device 122, to set an amount for a bid. In some aspects, bid amount selector 206 may be a sliding bar that sets the bid amount. In some aspects, other mechanisms for setting the bid amount may be used. For example, a keypad may be displayed for entering a desired bid amount, pre-defined bid increments (5, 10, 25, etc.) may be presented that the user may select individually or in combination to achieve a desired bid amount.

Bid/vote element 208 is activatable by the remote user 102 to submit a bid, for example at the amount set by the bid amount selector 206.

In some aspects, remote users 102 may also or alternatively vote on the movement command 202 to be executed by the live avatar using crowd sourcing. For example, the remote users 102 may activate one of movement commands 202 and activate the bid/vote element 208 to enter a vote for the activated movement command 202. Depending on the number of votes for each movement command 202, one of the movement commands 202 may be transmitted to the avatar system 150 for execution by the live avatar. For example, if 50 remote users 102 are voting on movement commands 202 and a plurality of them vote for a particular movement command 202, e.g., “pan left”, the “pan left” command may be transmitted to avatar system 150 for execution by the live avatar. In some aspects, for example, intermediary system 130 may receive the votes from the users and determine the command to be transmitted to avatar system 150 based on the tally of the votes. For example, if 60% of the votes want to pan left and 40% want to pan right, the avatar may be commanded to pan left but the amount of panning may be controlled by the percentage of votes each way. For example, the avatar may only pan 60% of the way to the left. In this manner, the avatar may be controlled through crowd sourcing by performing movements and actions based on the voting of all of the remote users 102 currently riding that avatar. In some aspects, the votes or commands may be received and aggregated together, e.g., by intermediary server 130 or directly by avatar system 150, to determine the command to be performed. In some aspects, inorganic or robotic avatars may also be controlled through crowd sourcing as described above.

In some aspects, system 100 may provide remote users 102 with an event virtual space. For example, in addition to providing remote users 102 that have virtual reality equipment with a virtual reality experience, avatars and other event attendees may utilize augmented reality glasses to provide added interaction with the remote users 102. For example, the event virtual space may mimic the physical layout of the event venue and may be updated in real-time based on inputs received from avatars and other attendees that utilize augmented reality glasses. The remote users 102 may then enter the event virtual space by purchasing or bidding on a virtual reality avatar and may use the virtual reality avatar to communicate with the avatar or other attendees through the event virtual space. In some aspects, access to the event virtual space may be limited and include an entry fee to eliminate untoward behavior. In some aspects, bidding may be used to add “weight” to the virtual reality avatar, such that physical avatars and augmented reality users can filter the percentage of VR avatars (if any) that they wish to see. For example, a celebrity physical or “broadcast” avatar may choose to see particular avatars based on selected criteria. For example, the celebrity physical or “broadcast” avatar (e.g., live avatar) may select to only see the top 1% of virtual avatars, e.g., the top 1% highest bidders, or even the single highest bidder. The live avatar may interact with the virtual avatar as though they were in the physical venue. For example, remote users 102 riding the live avatar may communicate or command the live avatar to communicate directly with the virtual reality avatar in the same way they would when live avatar is talking to a physical person.

Referring again to FIG. 1, in some aspects, the avatar system 150 may include a sentiment feedback component 164. Sentiment feedback component 164 may include, for example, clothing, items, or other devices that may be worn by or attached to the avatar that provide sentiment feedback to the live venue. For example, a live avatar may wear a headband, armbands, shirt, vest, or any other article that may include sentiment feedback component 164. In some aspects, for example, a robotic avatar may include lights, light emitting diodes (LEDs), display panels, speakers, or other similar components that may perform the function of sentiment feedback component 164. Sentiment feedback component 164 may provide feedback to the event venue, live event attendees and event participants, for example, through the use of audio or visual feedback. For example, sentiment feedback component 164 may include LEDs or other similar lighting elements that may be activated to show the event venue or event participant a sentiment of remote users 102 that are riding the avatar. For example, if the remote users 102 are angry or unhappy with a particular participant of the event, the sentiment feedback component 164 may be controlled or commanded by the remote users 102 to turn red. As another example, the remote users 102 may vote on a color or color scheme for the sentiment feedback component 164 such that the participants of the event may see the color. For example, if a team's colors are white and blue, the remote users 102 may vote to display the team's colors so that the team may know that they have support from the remote users 102 even if the actual attendees of the venue are fans of the other team. Any other color for any other sentiment may also be used.

In some aspects, for example, the sentiment feedback may be in the form of pre-recorded or computer generated audio outputs. For example, when the remote users 102 are unhappy, the Sentiment feedback component 164 may output a “boo” sound while if the remote users are happy the Sentiment feedback component 164 may output a “yay” sound. In some aspects, a remote user 102 may propose a message to be output and the other remote users may approve or deny the message to be output, for example, by voting. For example, a remote user 102 may propose the message “GO ROGER!!”. The other remote users 102 may then vote on whether the sentiment feedback component 164 will output the message.

In some aspects, sentiment feedback component 164 may be a screen, display, or other visual output held by or attached to the avatar that provides a visual sentiment to the event venue. For example, the remote users 102 may vote on a particular picture or image to be displayed on the screen.

Sentiment feedback component may be configured or adapted to provide sentiment feedback to the event venue based on a sentiment of the remote users 102 riding the avatar. For example, remote users 102 may vote on a current sentiment feedback for the live avatar. Once votes have been cast, the sentiment having the plurality of the votes may be output to sentiment feedback component 164 for presentation to the event venue. This allows the participants and other attendees of the event venue to know the sentiment of the remote users 102 riding the avatar.

In some aspects, avatar system 150 may also present to the event venue an indication of the number of remote users 102 that are riding the avatar. For example, if 100 users are riding the avatar, the number 100 may be presented by avatar system 150 to the event venue. In some aspects, intermediary system 130 or avatar system 150 may track the number of connected remote users 102 to determine the number to present to the event venue. In some aspects, for example, sentiment feedback component 164 may be utilized to also present the number of remote users 102 to the venue. This presentation may be used, for example, by celebrities that are attempting to get the maximum amount of exposure at the event venue. For example, a celebrity may be more inclined to answer questions asked by an avatar that has a large number of remote users 102 riding the avatar.

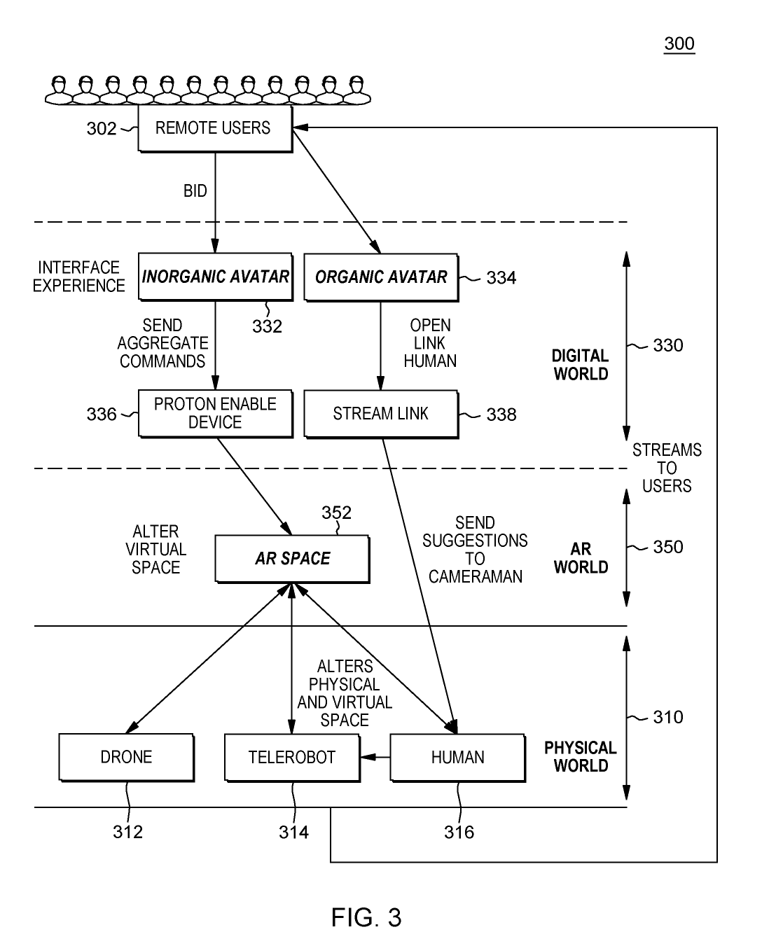

With reference now to FIG. 3, a diagram 300 is illustrated. Diagram 300 provides example connections between remote users 102 (302 in FIG. 3) and the avatar system 150 (FIG. 1). For example, diagram 300 demonstrates two paths for communication between the digital world and physical world. The organic Avatar uses the digital space to interact with the physical world to provide the experience requested. A second path or experience uses the inorganic Avatar and virtual or augmented reality. In this scenario communication may be passed through the AR space so it can be altered or enhanced.

At the top of diagram 300, remote users 302 are illustrated. Remote users 302 interact with the physical world 310 at the event venue through a digital world 330 and in some aspects an augmented reality (AR) world 350. For example, remote users 302 may utilize a virtual reality headset, tv, or other visual output 118 (FIG. 1) and audio output 120 (FIG. 1) to experience the physical world 310 as streamed to the remote users 302 by the avatar system 150 (FIG. 1), e.g., from video input 158 (FIG. 1) and audio input 160 (FIG. 1), of the live avatar. In some aspects, intermediary system 130 may host or implement the digital work 330, AR world 350, or both in addition to brokering access to the avatar.

In some aspects, the digital world 330 presents the remote users 302 with an interactive experience where they may select and bid on access or control rights for both robotic (inorganic) avatars 332 and live (organic) avatars 334. For example, remote users 302 may utilize the user interface 200 from FIG. 2 to perform bidding as described above to obtain access or control rights for either or both of robotic avatars 332 or live avatars 334.

Depending on the selected type of avatar, digital world 330 may provide a proton enabled device 336 or a stream link 338 to the relevant avatar. Proton enabled devices may include, for example, devices having a type of performance enhancement for 4G mobile networks that enables users to easily connect to highly integrated wireless networks. In some aspects, for example, a remote user 302 that selected a robotic avatar 332 may send aggregate commands, e.g., using input device 122, to a proton enabled device 336 which then may command the robotic avatar 332, e.g., a drone 312 or telerobot 314, to perform certain actions. For example, each servo or motor on a robot avatar may be separately proton enabled. In some aspects, the proton enabled device 336 may alter the virtual space to create an AR space 352 in the AR world 350 based on the aggregate commands received from remote users 302, e.g., movement commands 202 (FIG. 2), which are then sent to the robotic avatars 332 such as, for example, drone 312 or telerobot 314. For example, the aggregate commands may set indicators or “waypoints” in the AR space 352 for the robotic avatar 332 to follow. In some aspects, for example, virtual cues, lanes and signs can change, be altered, or be augmented within the AR space 352 by commands for the inorganic avatars within the virtual experience. In some aspects, the aggregate commands may cause the robotic avatar to interact with the physical world, for example, by shining a spotlight on an object in the physical world to draw a referee's attention. Any changes in the physical world may be streamed and mirrored to the AR world.

In some aspects, for example, a remote user 302 that selected a live avatar 334 may open a streaming link 338 to the live avatar 334, for example, a human 316 in the physical world 310 to receive a stream of the live avatar experience from the live avatar 334, e.g., via user computing device 110 (FIG. 1).

In some aspects, the inorganic entities in the physical world 310, e.g., drones 312, telerobots 314, or organic entities, e.g., humans 316, may also alter the AR space 352. For example, when remote users 302 request that an avatar view a particular object, augmented data about the object may be provided in the AR world 350 for the remote user's consumption. As an example, if an avatar is walking or moving down a street lined with shops, the AR world may provide popups, menus, or other similar indicators to remote users riding the avatar to provide more information on the shops, for example, based on the location of the avatar and commonly available information on the internet about shops located in that location. In another example, if an avatar is at the grand canyon, for example, the AR world may provide an estimated height of the canyon at the location where the avatar is looking or other similar information

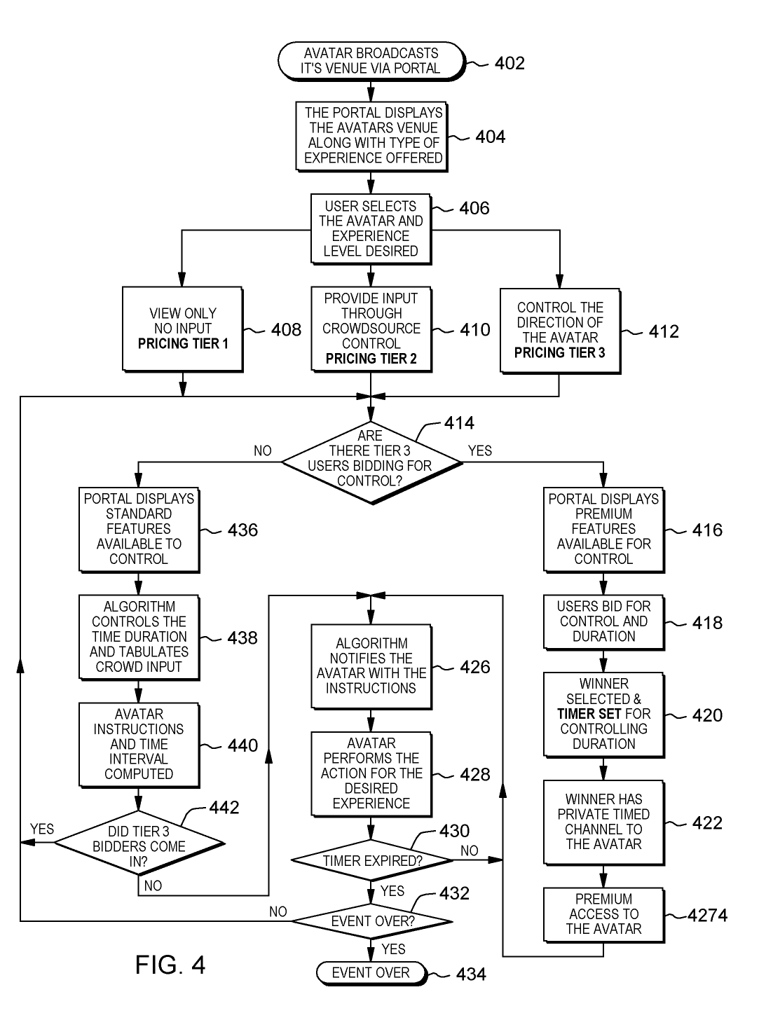

With reference now to FIG. 4, a method for controlling avatars is illustrated. At 402, an avatar, e.g., robotic or live avatar, broadcasts the venue that the avatar is covering to the remote users 102 (FIG. 1). The avatar may broadcast the venue, for example, via a portal or intermediary system 130 (FIG. 1). In some aspects, for example, intermediary system 130 may provide web hosting capabilities for the avatars where, for example, remote users 102 may log into intermediary system 130 using user computing devices 110 to view, select, and bid on access and control rights for avatars.

At 404, the portal, e.g., intermediary system 130, presents the available avatars including an identification of their venue and current status, bids, experience offered, etc.

At 406, the portal receives a selection of an avatar and an experience level for the avatar from the remote user 102. For example, the remote user may select the avatar from the portal using input device 122 and may select an experience level that the remote user desires. For example, at 408 the remote user 102 may select a first pricing tier which allows the remote users 102 to ride the avatar in a view only mode with no input. As another example, at 410, the remote user 102 may select a second pricing tier which allows the remote user 102 to ride the avatar for viewing and also provide input through crowd source control of the avatar. As another example, at 412, the remote user 102 may select a third pricing tier which allows the remote user 102 to ride the avatar for viewing and directly control the avatar. The prices for each of the first, second, and third pricing tiers may vary, for example, based on supply and demand. Although three pricing tiers are described, any number of pricing tiers and corresponding levels of control of the avatars may be implemented without departing from the scope of the present disclosure.

At 414, the portal determines whether there are any remote users 102 that selected the third pricing tier. If more than one remote user 102 has selected the third pricing tier, the portal presents premium features that are available for bidding on control of the avatar at 416. For example, the portal may present available control time slots, speaking rights, sentiment feedback rights, or any other feature of the avatar that may be controlled. For example, the portal may present the move commands 202 illustrated in FIG. 2 to the remote users 102 via visual output 118. In some aspects, all control features for the avatar may be bid on by a single bid.

At 418, the remote users 102 that selected the third pricing tier may bid on the control and duration features for the avatar.

At 420, the remote user 102 that wins the bidding gains, e.g., has the highest bid, gains control of the avatar and a timer is set for the duration of the bid control, e.g., timer 204 (FIG. 2).

At 422, a private timed communication channel is opened between the remote user 102 that wins the bidding and the avatar, e.g., a computing device 110 of the winning remote user 102 and avatar system 150 via network interfaces 116 and 156. In some aspects, for example, the private timed communication channel may be a direct connection between the computing device 110 and avatar system 150. In some aspects, for example, the private timed communication channel may be controlled via intermediary system 130.

At 424, the winning remote user 102 is granted access to control the avatar.

At 426, any controls submitted by the winning remote user 102, e.g., via a computing device 110 associated with the remote user 102, are transmitted from the portal, e.g., intermediary server 130 to the avatar system 150 for execution by the live avatar.

At 428, the avatar performs executes actions corresponding to the submitted controls to provide the winning remote user with the desired experience.

At 430, the portal, e.g., intermediary server 130, determines whether the timer for the current time slot has expired, e.g., whether the winning remote user 102's time for controlling the avatar or the crowd sourced control time has expired. If the timer has expired, the winning remote user 102's access to control the avatar is revoked and the communication channel between the winning remote user 102 and the avatar is closed or the crowd source control of the avatar is revoked and the method proceeds to 432. If the timer has not expired, the avatar continues receiving commands either from the wining remote user 102 or the crowdsource commands at 426.

At 432, intermediary server 130 determines whether the event is over. If intermediary system 130 determines that the event is over, the method ends at 434.

If intermediary system 130 determines that the event is not over, the method returns to 414.

Returning again to 414, if there were no remote users 102 that selected third pricing tier, the portal displays the standard features that are available for control at 436. The standard features may include, for example, the features described above with respect to 416. As another example, standard features may include features available at the crowd source control level and may provide a finite set of control points, e.g., panning the camera, zoom in, zoom out, etc.

At 438, a timing window opens for crowd source voting by the remote users that selected the second pricing tier for each of the features. For example, the remote users 102 may vote on movement, commands, sentiment, or other features of the avatar.

At 440, the timing window for crowd source voting ends and the votes are tallied to determine the commands to be transmitted to the avatar system 150. For example, the command or commands with the highest vote, e.g., in each category of commands such as movement, view, sentiment, etc., may be transmitted to the avatar system 150 for execution by the avatar.

At 442, the portal determines whether any new remote users 102 at the third pricing tier have joined the avatar. If new remote users 102 at the third pricing tier have joined, the method returns to 414 and bidding commences for those remote users 102. If no new remote users 102 at the third pricing tier have joined, the determined commands are transmitted to the avatar system 150 at 426.

The method then continues at 428 with the avatar executing the commands as described above.

In some aspects, so long as intermediary system determines that the event is not over at 432, additional commands may be transmitted to the avatar from the crowd sourcing of 436-440 or from the winning bidder of 416-424.

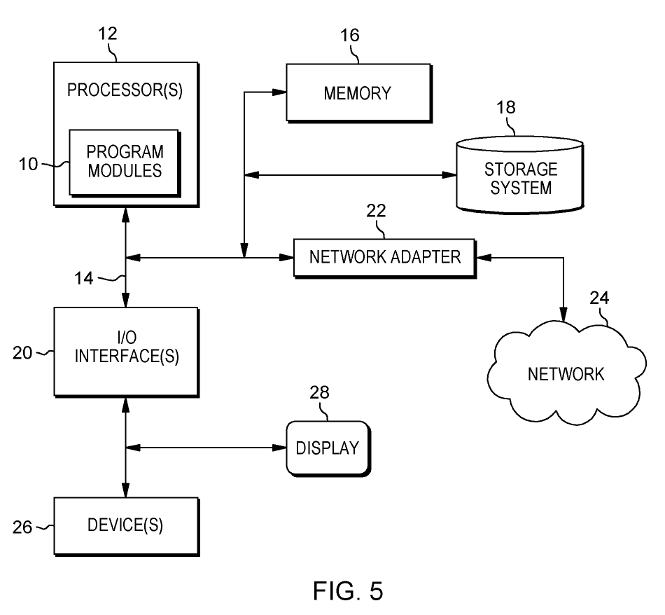

FIG. 5 illustrates a schematic of an example computer or processing system that may implement any portion of system 100, computing devices 110, intermediary system 130, avatar system 150, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a software module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

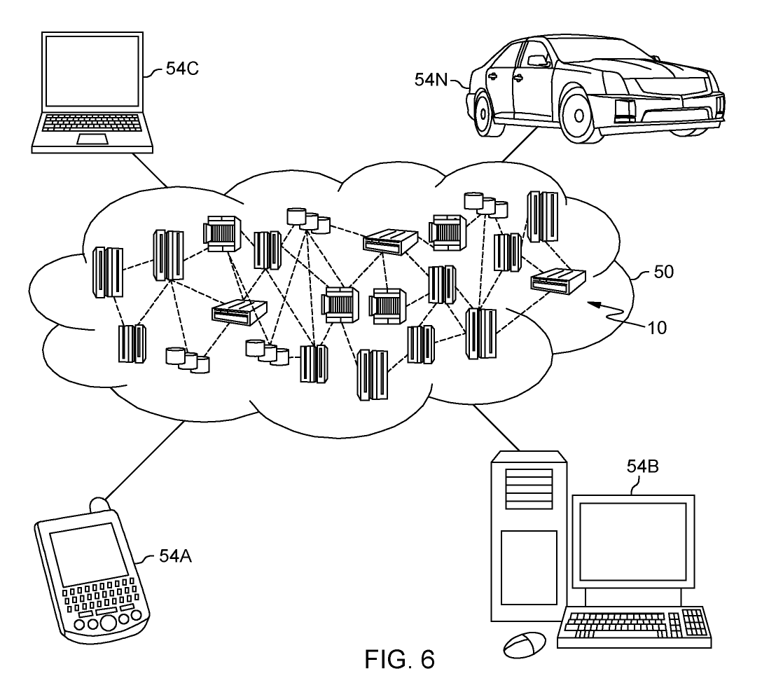

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

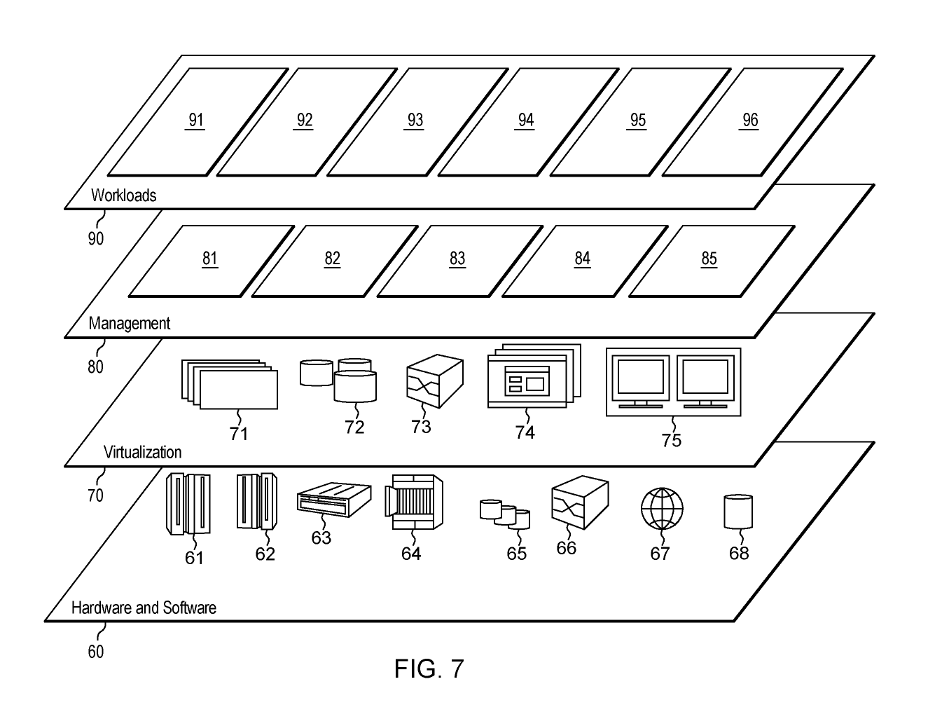

Referring now to FIG. 7, a set of functional abstraction layers provided by cloud computing environment 50 (FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and bidding or voting on the control of avatars 96.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1-7. (canceled)

8. A system comprising at least one hardware processor configured to:
receive a broadcast from an avatar, the broadcast comprising an indication of a venue that the avatar is attending;
receive a selection of the avatar by a plurality of remote users;
receive from the avatar a transmission of a live video stream;
transmit the live video stream to the plurality of remote users;
receive votes from at least some of the plurality of users for control of the avatar, each vote comprising a command to be performed by the avatar;
determine, based on the received votes, a selected command to be performed by the avatar;
transmit the selected command to the avatar for execution by the avatar;
receive sentiment feedback for the event from the plurality of users; and
transmit the sentiment feedback to the avatar, the transmission of the sentiment feedback to the avatar configured to cause the avatar to present the sentiment feedback to other participants located at the event venue.

9. The system of claim 8, the at least one hardware processor further configured to:
determine that a premium remote user has selected the avatar, the premium remote user having selected a pricing tier that is more expensive than a pricing tier selected by the plurality of remote users;
receive from the premium remote user a bid for control of the avatar;
determine that the received bid is a highest bid received for control of the avatar;
in response to determining the received bid is the highest bid, provide the premium remote user with control of the avatar;
receive from the premium remote user a selection of a command to be performed by the avatar; and
transmit the command selected by the premium remote user to the avatar for execution by the avatar, wherein the command selected by the premium remote user overrides the command selected based on the received votes.

10. The system of claim 9,
wherein the avatar is a live person,
wherein the selection of the command by the premium remote user comprises the premium remote user speaking a command, and
wherein transmitting the command selected by the premium remote user to the avatar comprises transmitting the spoken command to the avatar for output to the avatar by an audio output device of the avatar.

11. The system of claim 9, wherein the bid received from the premium remote user corresponds to a first time slot, the at least one hardware processor further configured to:
determine that the first time slot has ended; and
disable the premium remote user's control of the avatar.

12. The system of claim 8, wherein the avatar is a live person, the at least one hardware processor further configured to:
receive from the avatar an audio description of the venue; and
transmit the audio description of the venue to the plurality of remote participants.

13. The system of claim 8, wherein the sentiment feedback comprises at least one sound, the avatar configured to present the at least one sound to the other participants located at the event venue via at least one audio output.

14. The system of claim 8, wherein the sentiment feedback comprises at least one color, the avatar configured to present the at least one color to the other participants located at the event venue via at least one display device.

15. A non-transitory computer readable medium comprising instructions that, when executed by at least one hardware processor, configure the at least one hardware processor to:
receive a broadcast from an avatar, the broadcast comprising an indication of a venue that the avatar is attending;
receive a selection of the avatar by a plurality of remote users;
receive from the avatar a transmission of a live video stream;
transmit the live video stream to the plurality of remote users;
receive votes from at least some of the plurality of users for control of the avatar, each vote comprising a command to be performed by the avatar;
determine, based on the received votes, a selected command to be performed by the avatar;
transmit the selected command to the avatar for execution by the avatar;
receive sentiment feedback for the event from the plurality of users; and
transmit the sentiment feedback to the avatar, the transmission of the sentiment feedback to the avatar configured to cause the avatar to present the sentiment feedback to other participants located at the event venue.

16. The non-transitory computer readable medium of claim 15, the instructions further configuring the at least one hardware processor to:
determine that a premium remote user has selected the avatar, the premium remote user having selected a pricing tier that is more expensive than a pricing tier selected by the plurality of remote users;
receive from the premium remote user a bid for control of the avatar;
determine that the received bid is a highest bid received for control of the avatar;
in response to determining the received bid is the highest bid, provide the premium remote user with control of the avatar;
receive from the premium remote user a selection of a command to be performed by the avatar; and
transmit the command selected by the premium remote user to the avatar for execution by the avatar, wherein the command selected by the premium remote user overrides the command selected based on the received votes.

17. The non-transitory computer readable medium of claim 16,
wherein the avatar is a live person,
wherein the selection of the command by the premium remote user comprises the premium remote user speaking a command, and
wherein transmitting the command selected by the premium remote user to the avatar comprises transmitting the spoken command to the avatar for output to the avatar by an audio output device of the avatar.

18. The non-transitory computer readable medium of claim 16, wherein the bid received from the premium remote user corresponds to a first time slot, the instructions further configuring the at least one hardware processor to:
determine that the first time slot has ended; and
disable the premium remote user's control of the avatar.

19. The non-transitory computer readable medium of claim 15, wherein the avatar is a live person, the instructions further configuring the at least one hardware processor to:
receive from the avatar an audio description of the venue; and
transmit the audio description of the venue to the plurality of remote participants.

20. The non-transitory computer readable medium of claim 15, wherein the sentiment feedback comprises at least one sound, the avatar configured to present the at least one sound to the other participants located at the event venue via at least one audio output.

21. The non-transitory computer readable medium of claim 15, wherein the sentiment feedback comprises at least one color, the avatar configured to present the at least one color to the other participants located at the event venue via at least one display device.

22. The system of claim 8, the at least one hardware processor further configured to:
receive a proposed message from a remote user of the plurality of remote users for presentation by the avatar to the other participants located at the event venue;
receive votes on the proposed message from at least some of the plurality of remote users;
determine, based on the received votes on the proposed message that the proposed message should be presented by the avatar; and
transmit the proposed message to the avatar as the sentiment feedback, the avatar configured to present the proposed message to other participants located at the event venue.

23. The non-transitory computer readable medium of claim 15, the instructions further configuring the at least one hardware processor to:
receive a proposed message from a remote user of the plurality of remote users for presentation by the avatar to the other participants located at the event venue;
receive votes on the proposed message from at least some of the plurality of remote users;
determine, based on the received votes on the proposed message that the proposed message should be presented by the avatar; and
transmit the proposed message to the avatar as the sentiment feedback, the avatar configured to present the proposed message to other participants located at the event venue.

24. The system of claim 8, the at least one hardware processor further configured to:
determine a number of the plurality of remote users that have selected the avatar;
transmit to the avatar the determined number, the avatar configured to present the determine number to the other participants located at the event venue via at least one display device.

25. The non-transitory computer readable medium of claim 15, the instructions further configuring the at least one hardware processor to:
determine a number of the plurality of remote users that have selected the avatar;
transmit to the avatar the determined number, the avatar configured to present the determine number to the other participants located at the event venue via at least one display device.
